(19) United States
(12) Patent Application Publication
(10) Pub. No.: US 2005/0129456 A1
(43) Pub. Date: Jun. 16, 2005

(54) Crutch apparatus and method

(76) Inventor: Peter Van Der Sluis, Ridgeway, Ontario (CA)

Correspondence Address: SNELL & WILMER;ONE ARIZONA CENTER, 400 EAST VAN BUREN, PHOENIX, AZ, 850040001, US

(21) Appl. No.: 10/709,473

(22) Filed: May 7, 2004

Related U.S. Application Data
(60) Provisional application No. 60/469,513, filed on May 9, 2003.

(51) Int. Cl. A61H 3/02

(52) U.S. Cl. 403/109.1; 135/68

(57) ABSTRACT

An improved crutch device generally includes a gel shock, a fixed tube assembly, and a sliding tube assembly. The present invention is configured to facilitate dampening the impact and preventing or mitigating injuries at least partially caused by the use of a device, wherein the device (e.g., crutch) provides support or assists movement, such as, for example, canes, crutches and forearm crutches.

### CROSS REFERENCE TO RELATED APPLICATIONS

This application claims priority to, and the benefit of, U.S. Provisional Application Ser. No. 60/469,513 filed on May 9, 2003 and entitled “System and Method for an Improved Crutch Device”, the entire contents of which is hereby incorporated by reference.

### FIELD OF INVENTION

The present invention generally relates to a crutch device, and more particularly, to a crutch device configured to facilitate dampening upon impact.

### BACKGROUND OF INVENTION

Crutches and similar devices are commonly used to assist individuals with mobility for a variety of reasons. However, consistent use of such devices can cause many different types of injuries, including, for example, injuries to cartilage, tendons, and joints of the wrist, forearm, and shoulder, and soft tissue damage to underarm areas.

Prior art devices have used various springs when trying to insulate the impact of the crutch with the ground. Although the use of a spring is somewhat successful, problems can exist, such as, for example, bouncing or skipping on hard surfaces when striking the ground at an incident angle, which can cause traction problems. Therefore, a need exists for a crutch device that provides better insulation during the use of crutches and similar instruments, while also helping to protect against possible traction problems.

### SUMMARY OF INVENTION

The improved crutch device, in one embodiment, generally includes a gel shock, a fixed tube assembly, and a sliding tube assembly. The fixed tube assembly may be connected to, or integrated with, a crutch, cane, forearm crutch, and the like. The use of the crutch device facilitates dampening the impact from the crutch on the user's body.

### BRIEF DESCRIPTION OF DRAWINGS

A more complete understanding of the present invention may be derived by referring to the detailed description and claims when considered in connection with the Figures, where like reference numbers refer to similar elements throughout the Figures, and:

FIG. 1 illustrates the exemplary components of the device in a compressed position; and

FIG. 2 illustrates the exemplary components of the device in an extended position.

### DETAILED DESCRIPTION

The detailed description of exemplary embodiments of the invention herein makes reference to the accompanying drawings and pictures, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation.

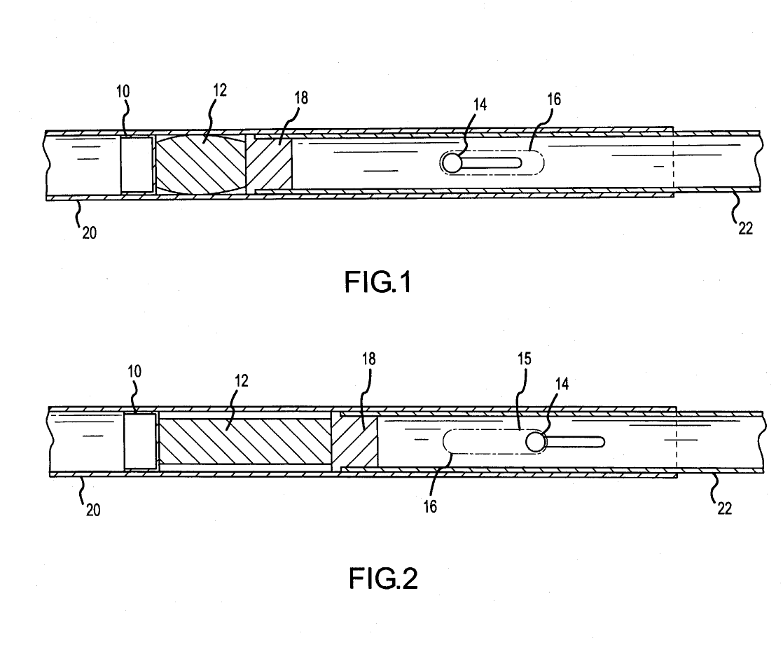

The crutch device, in one embodiment and with reference to FIG. 1, generally includes a fixed stop 10, a gel shock 12, a spring pin 14, a fixed tube 20, a slide tube assembly 22, and a plug 18. The present invention is configured to facilitate dampening the impact and preventing or mitigating injuries at least partially caused by the use of a device, wherein the device (e.g., crutch) provides support or assists movement, such as, for example, canes, crutches and forearm crutches. The invention also provides greater comfort and longer periods of use of such devices, thereby minimizing overuse injuries of, for example, cartilage, tendons and joints of the wrist, forearm and shoulder and reducing soft tissue damage to underarm areas. The invention also increases the friction with certain surfaces and improves traction because the device is not as likely to bounce or skip on hard surfaces when striking at an incident angle. Because the invention includes a compressible material with varying densities (e.g., gel shock 12), the system can be readily formatted for users of different weights, ages and athletic abilities. The length of the gel tube and its density can accommodate a lightweight elderly person needing cushioning for fragile joints and soft tissue (e.g., long tube with low density). The invention also works for a heavy football player overcoming a sport injury needing higher density gel tube to compensate for the weight and less cushioning (e.g., shorter gel tube) to allow quick forward progress while limiting injury potential from a high repetition shock.

As used herein, a support device may include any device, system, hardware and/or software suitably configured to facilitate supporting or assisting an individual, item or object. In one embodiment, the support device may include a cane, crutch, forearm crutch, or like device.

The weight of the invention which interfaces with the support device is almost negligible relative to the support device, thus the invention is not unwieldy. In one embodiment, the weight of the invention components is centered near the handhold and not at an extremity and therefore does not substantially increase muscular/joint stress when moving it forward as it would if located at the lower extremity. Moreover, the location of the invention near to hand height minimizes the possibility that the invention is effected by mud, snow or ground debris which could prematurely wear components or temporarily jam sliding mechanisms. Furthermore, the invention components (as opposed to a rubber cane tip used for absorbing shock) are not substantially or easily affected by the extreme cold because the invention components are not directly against the surfaces of snow or ice which can quickly change core temperatures and harden most materials, thereby reducing the materials' shock absorbing qualities.

With continued reference to FIG. 1, fixed tube assembly 20 may be located at the top section of a support device where the crutch device is held by the user and is generally considered the stationary part of the crutch device. Fixed tube assembly 20 may be any shape, diameter (constant, varied, stepped, etc) and made from any suitable material. In one embodiment, fixed tube assembly 20 is a cylindrical tube comprised of a sturdy metallic alloy or plastic. Fixed tube assembly 20 receives slide tube assembly 22 at the bottom end of the fixed tube assembly. As used herein, top may be toward the end which interfaces with or supports the individual, while bottom may be toward the end which impacts the surface (e.g., ground).

Slide tube assembly 22 may be located at the bottom end of the device and is configured with a smaller diameter than fixed tube assembly 20 thereby allowing slide tube assembly to be received in the bottom end of fixed tube assembly 20. However, in other embodiments, fixed tube assembly 20 may be configured with a smaller diameter than slide tube assembly 20 thereby allowing fixed tube assembly to be received in the top end of slide tube assembly 22. It should be appreciated that the invention may include any configuration of crutch device that allows fixed tube assembly 20 and slide tube assembly 22 to move substantially freely, while being joined together. Slide tube assembly 22 may be any shape, diameter (constant, varied, stepped, etc) and made from any suitable material. In one embodiment, slide tube assembly 22 is a cylindrical tube comprised of a sturdy metallic alloy or plastic.

The gel shock 12 may be placed in any position that allows it to dampen the impact of the support device or between fixed tube assembly 20, fixed stop 10 and slide tube assembly 22. In one embodiment, gel shock 12 may be positioned between fixed tube assembly 20 and slide tube assembly 22 and inside fixed tube assembly 20. Generally, the gel shock may include any material that compresses under a load. Gel shock may also be elastic in nature, allowing the gel shock to be compressed and return to its substantially original profile. For example, the gel shock returns to its original profile within milliseconds of the load being released. In addition, gel shock may be thermally stable. The gel shock is much more advantageous than a spring because the gel shock does not, for example, similarly wear, change spring characteristics/force or make similar irritating noises. Moreover, different types and viscosities of gel shocks may be used depending on the height and weight of the individual user.

In one embodiment, gel shock 12 is positioned between fixed stop 10 and slide tube plug 18. Slide tube plug 18 may be attached to one end of slide tube assembly 22. The slide tube plug 18 may be fixed at the end of the slide tube assembly nearest to the fixed tube assembly. Gel shock 12 may rest upon slide tube plug 18. The side tube plug may be any shape and made of any material that is able to interface with and support the gel shock. The slide tube plug caps the end of the slide tube assembly.

Fixed stop 10 may be affixed in the interior of fixed tube assembly 20. The fixed stop may be of any material and shape that enables it to be secure and allows the gel shock and slide tube assembly to compress against it. Fixed stop 10 may be a plug that is pressure fitted or riveted into place. It should be noted that any system or method to secure the fixed stop inside the fixed tube assembly 20 may be used. The maximum distance between fixed stop 10 and slide tube plug 18 may be approximately the distance of the length of the gel shock in its original profile. However, it should be noted that the distance between the fixed stop and slide tube plug may be any distance that allows the gel shock to cushion the interaction between the slide tube assembly 22 and fixed tube assembly 20.

Spring pin 14 removably locks slide tube assembly 22 to fixed tube assembly 20. In one embodiment, spring pin is a dowel which protrudes through the side of the slide tube assembly. The spring pin may be composed of any material and be any shape that allows it to secure the sliding tube assembly to the fixed tube assembly. A spring loaded clip 15, as best seen in FIG. 2, may be attached to the back of the spring pin 14 to allow the spring pin 14 to be forced outwards once the spring pin 14 is released after being pushed down, thus allowing the spring pin to function as a locking button. It should be noted that any device may be used to secure the fixed tube assembly to the sliding tube assembly such as, for example, a dowel, bolt, clip, and the like.

By pressing spring pin 14, the user is able to slide the slide tube assembly 22 into the fixed tube assembly 20. As seen in FIG. 1, when the spring pin is depressed and placed properly, the spring pin may pass through slot 16 in the fixed tube assembly. The slot 16 may be of any shape or design, as long as it allows the spring pin to pass through, thus securing the fixed tube assembly 20 and sliding tube assembly 22 together. In one embodiment, slot 16 is a channel in fixed tube assembly 20, thus allowing the sliding tube assembly 22 to slide up and down within the fixed tube assembly, while at the same time securing the two assemblies together. It should be noted, however, that although the combination of the spring pin 14, spring loaded clip 15, and slot 16 secure the slide tube assembly 22 in the fixed tube assembly 20, any configuration that secures the two assemblies together may be used.

When a load is place on the support device by the user, the gel shock will compress, dampening the impact for the user. The design of slot 16 allows the slide tube assembly 22 to slide further inside the fixed tube assembly 20, without being stopped by the spring pin. In addition, when the load is released, the gel shock 12 returns to its substantially original profile and the crutch device once again may be in the extended position, as best shown in FIG. 2.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the invention. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”.

1. A system configured to facilitate dampening the impact from use of a support device, said system including:
a fixed tube assembly having a fixed stop at a first end;
a slide tube assembly having a plug at a first end;
said first end of said fixed tube assembly slidably engaging with said first end of said slide tube assembly; and,
a gel shock located between said fixed stop and said plug.

2. The system of claim 1, wherein said fixed stop is at least one of pressure fitted and riveted into said first end of said fixed tube assembly.

3. The system of claim 1, further comprising a spring pin attached to said slide tube assembly.

4. The system claim 1, further comprising a slot in said fixed tube assembly.

5. The system of claim 1, further comprising a spring pin attached to said slide tube and a slot in said fixed tube assembly, wherein said spring pin and slot interact to secure said slide tube assembly and said fixed tube assembly together while allowing said fixed tube assembly and said slide tube assembly to slidably engage.

6. The system of claim 1, wherein said slide tube assembly is slidably engaged into said fixed tube assembly.
